(19) United States
(12) Patent Application Publication
(10) Pub. No.: US 2005/0218806 A1
(43) Pub. Date: Oct. 6, 2005

(54) Method for manufacturing a plasma display panel

(75) Inventors: Masahiro Sawa, Kawasaki (JP); Hideki Harada, Kawasaki (JP); Masayuki Shibata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 10/988,660

(22) Filed: Nov. 16, 2004

(30) Foreign Application Priority Data
Mar. 31, 2004 (JP) 2004-107832

(51) Int. Cl. H01J 17/49

(52) U.S. Cl. 313/582

(57) ABSTRACT

A method for manufacturing a plasma display panel, according to the present invention includes the steps of forming a transparent conductive film in at least a display region on a glass substrate, partly forming bus electrodes in parallel on the transparent conductive film, cutting the transparent conductive film and the glass substrate by a sandblasting method into a predetermined configuration to form parallel transparent electrodes of a predetermined shape and to form recesses in the glass substrate between the transparent electrodes, forming a dielectric layer to cover the bus electrodes and the transparent electrodes, and forming a protective layer to cover the dielectric layer.

### CROSS-REFERENCE TO RELATED APPLICATION

This application is related to Japanese application No. 2004-107832 filed on Mar. 31, 2004, whose priority is claimed under 35 USC § 119, the disclosure of which is incorporated by reference in its entirety.

### BACKGROUND OF THE INVENTION

1. Field of the Invention

The present invention relates to a method for manufacturing a structure around a display electrode of a plasma display panel.

2. Description of Related Art

Japanese Unexamined Patent Publication No. Hei 11(1999)-317172 discloses a plasma display panel (hereafter, referred to also as PDP) having a front substrate 110 on which a plurality of display electrodes 112 are arranged in parallel and a rear substrate on which a plurality of address electrodes are arranged in parallel, the front and rear substrates being opposed with ribs arranged therebetween, wherein the front substrate 110 has recesses 115 formed between the display electrodes 112a (at electric display gaps). In the PDP, forming the recesses 15 reduces a proportion of surface discharge to make electric discharges less subject to the interference from the ribs, and makes a discharge space larger to improve luminous efficiency. The above Japanese Unexamined Patent Publication No. Hei 11(1999)-317172 describes, as a background art, a method for manufacturing a PDP by forming the recesses 15 in a surface of the front substrate 110 through a sandblasting method and then by forming the display electrodes 112, a dielectric layer 113 and a protective layer 114 in this order.

With the above constitution, the method as the background art can improve luminous efficiency by generating electric discharges at the recess between the adjacent display electrodes as a pair, especially between opposed side surfaces of the adjacent display electrodes and thus by reducing a proportion of surface discharge. However, the background art has a problem that it increases a time required for manufacturing a PDP since it includes a sandblasting step for forming the recess in addition of ordinary manufacturing steps, namely since it requires the time for the sandblasting step for forming the recess in addition of the time ordinarily required for manufacturing the PDP. The background art also has another problem that the dielectric layer and the protective layer are formed, without taking into account the display electrodes between which the recess is formed and between which surface discharges are generated, to a predetermined thickness on the areas of the glass substrate other than an area where the recess is formed, causing unevenness in electric discharges per unit luminous area, resulting in inability of the PDP to perform stable driving operations although the PDP has the recess formed between the display electrodes.

### SUMMARY OF THE INVENTION

The present invention has been made to solve the above problems and a purpose thereof is to provide: a method for manufacturing a PDP having recesses formed between electrodes, the method adapted to shorten a time required for manufacturing a PDP; a PDP having recesses formed between display electrodes, the recesses being modified in shape for improving luminous efficiency and for providing the PDP to the ability to perform stable driving operations; a method for manufacturing the same.

The present invention provides a method for manufacturing a plasma display panel, comprising the steps of: forming a transparent conductive film in at least a display region on a glass substrate; partly forming bus electrodes in parallel on the transparent conductive film; cutting the transparent conductive film and the glass substrate by a sandblasting method into a predetermined configuration to form parallel transparent electrodes of a predetermined shape and to form recesses in the glass substrate between the transparent electrodes; forming a dielectric layer to cover the bus electrodes and the transparent electrodes; and forming a protective layer to cover the dielectric layer.

Thus, as compared with methods in which the transparent conductive film is patterned to form the transparent electrodes and then the recesses are formed in the glass substrate in a separate step, the method according to the present invention is advantageous in that the transparent electrodes and the recesses can be formed simultaneously by the sandblasting method, simplifying the manufacturing process.

### BRIEF DESCRIPTION OF THE DRAWINGS

FIG. 1(a) is a perspective view illustrating an essential part of a PDP according to a first embodiment of the present invention;

FIG. 1(b) is an enlarged view illustrating an essential part of FIG. 1(a);

FIG. 2(a) is an enlarged view illustrating an essential part of FIG. 1(b);

FIG. 2(b) is a view illustrating a part according to the prior art that corresponds to the essential part shown in FIG. 1(b);

FIG. 3 is a graph showing the relationship between an excavation amount d from a bottom portion and a firing voltage Vf according to the first embodiment;

FIGS. 4(a) to 4(m) are views showing states in steps of the method for manufacturing a PDP according to the first embodiment;

FIG. 5 is a schematic view illustrating the plasma CVD equipment according to a second embodiment of the present invention;

FIG. 6(a) is a perspective view illustrating an essential part according to the second embodiment; and

FIG. 6(b) is a perspective view illustrating an essential part according to the first embodiment.

### DESCRIPTION OF THE PREFERRED EMBODIMENTS

In the method according to the present invention, preferably, the cutting is carried out so that the recesses have a depth equal to or greater than a thickness given by subtracting a thickness of the transparent electrode from the sum of a thickness of the dielectric layer and a thickness of the protective layer. According to this method, a bottom portion of the recess is located at a level lower than a surface of the glass substrate that has the display electrodes formed thereon, and electric discharges follow not an electric line of force that makes a detour but one that is provided between the opposed surfaces of the adjacent transparent electrodes to remarkably reduce the firing voltage.

The formation of the dielectric layer may be carried out by a CVD method. According to this method, the dielectric layer has so small a dielectric constant and thickness that it can be easily controlled. Further, in contrast with unlike methods in which the dielectric layer is formed of a low-melting glass by the screen-printing method, the method using the CVD includes no firing step, thereby simplifying the process and reducing the effect of substrate shrinkage. Also, especially when the recess needs to be formed at the discharge gap as in the present invention, the method according to the present invention is advantageous in that, by utilizing a chemical reaction, the dielectric layer can be formed as a uniform film having a small thickness to follow the contour of the front substrate with preciseness of micro, although in general it is difficult to form the dielectric layer beneath the recess.

In the method according to the present invention, if necessary, the dielectric layer is formed of a dielectric sheet. This method includes a firing step like methods in which the dielectric layer is formed by the screen-printing method. However, the method using the dielectric sheet is advantageous in that the dielectric layer of the front substrate, which is formed of the dielectric sheet, can have a uniform thickness. Also, especially when the recess needs to be formed at the discharge gap as in the present invention, the method according to the present invention is advantageous in that, although in general it is difficult to form the dielectric layer beneath the recess, the dielectric layer can be formed as a uniform film having a small thickness to follow the contour of the front substrate, since in the method according to the present invention, the glass paste is dried to evaporate part of the solvent to the extent that the glass paste keeps a predetermined shape, unlike a low-melting glass paste used in methods in which the dielectric layer is made by the screen-printing method.

In the method according to the present invention, if necessary, the cutting is carried out so that the recesses have a taper. According to this method, the CVD method is used to form the dielectric layer on the front substrate by depositing a substance produced through a chemical reaction so that the dielectric layer is provided as a thin film having a substantially uniform thickness to follow the contour of the surface of a target on which the film is formed. Forming the recess with a taper facilitates deposition of the substance produced through a chemical reaction on the bottom portion of the recess to ensure the formation of the dielectric layer having a uniform thickness. When the dielectric layer is formed of a dielectric sheet, the recess can be formed without any perpendicular surfaces but with a wide angle formed between a bottom surface and side surfaces thereof. The recess with a taper makes it easier to laminate the dielectric sheet and to form the dielectric layer having a uniform thickness as compared with a recess with perpendicular surfaces.

A plasma display panel according to the present invention comprises: a front substrate that has a plurality pairs of display electrodes for generating surface discharges and that has recesses formed at discharge gaps between the adjacent display electrodes; and a rear substrate that has a plurality of address electrodes, the front and rear substrates being opposed, wherein a bottom portion of the recess is located at a level lower than a surface of the glass substrate that has the display electrodes formed thereon, and the front substrate has a dielectric layer that follows contours made by the display electrodes. Thus, the plasma display panel according to the present invention has a structure that the bottom portion of the recess is located at the level lower than the surface of the glass substrate that has the display electrodes formed thereon, and the front substrate has the dielectric layer that follows the contours made by the display electrodes. Therefore, the PDP has improved effects in thickness uniformity of the dielectric layer, driving operation, and yield rates or percentages of products that are identified as non-defectives.

In the PDP according to the present invention, if necessary, the display electrode is made of only a bus electrode. Thus, in the PDP according to the present invention, by adjusting the distance of the discharge gap and the shape of the bus electrode, the firing voltage can be reduced and also the step of forming the transparent electrode can be eliminated, thereby significantly saving the time required for manufacturing the PDP.

The present invention will now be explained in detail based on the preferred embodiment shown in the drawings. It should be understood that the present invention is not limited to the embodiment.

### First Embodiment

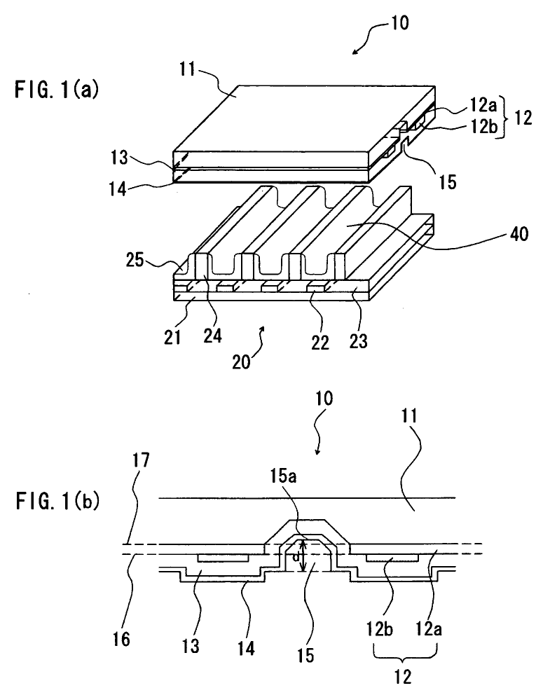

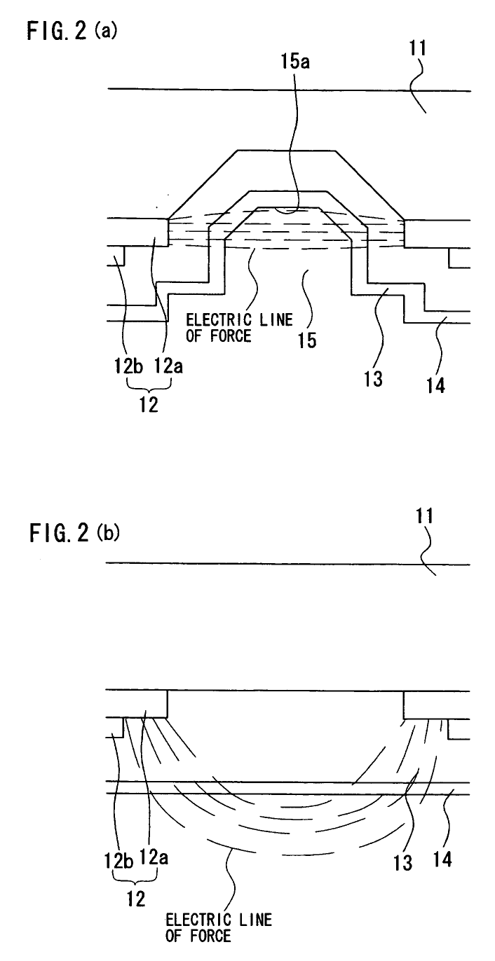

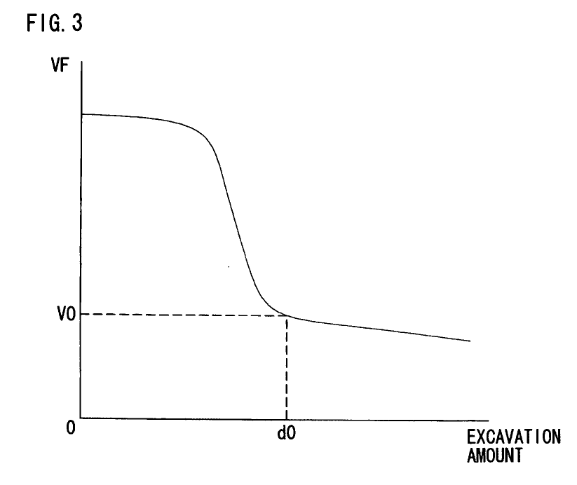

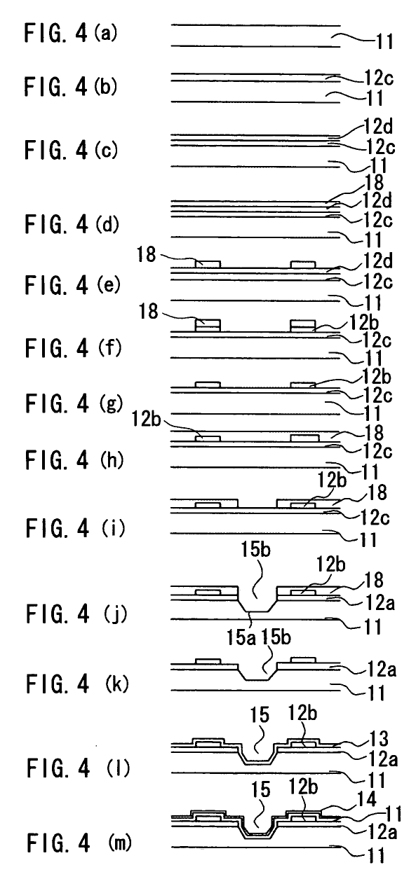

A method for manufacturing a PDP according to a first embodiment of the present invention will be explained with reference to the drawings. FIG. 1(a) is a perspective view illustrating an essential part of a PDP according to the first embodiment; FIG. 1(b) is an enlarged view illustrating an essential part of FIG. 1(a); FIG. 2(a) is an enlarged view illustrating an essential part of FIG. 1(b); FIG. 2(b) is a view illustrating a part according to the prior art that corresponds to the essential part shown in FIG. 1(b); FIG. 3 is a graph showing the relationship between an excavation amount d from a bottom portion and a firing voltage Vf according to the first embodiment; and FIGS. 4(a) to 4(m) are views showing states in steps of the method for manufacturing a PDP according to the first embodiment.

A method for manufacturing a PDP according to the first embodiment of the present invention comprises the steps of: forming a transparent conductive film 12c in at least a display region on a glass substrate 11; forming parallel bus electrodes 12b on the transparent conductive film 12c; patterning the transparent conductive film 12c and the glass substrate 11 by the sandblasting method into a predetermined configuration to form transparent electrodes 12a and recesses 15; forming a dielectric layer 13 to cover the transparent electrodes 12a and the bus electrodes 12b; and forming a protective layer 14 to cover the dielectric layer 13. The method according to the first embodiment is characterized in that it comprises, after the step of forming the bus electrodes 12b, the step of patterning the transparent conductive film 12c and the glass substrate 11 by the sandblasting method to form at once the transparent electrodes 12a and the recesses 15 in the glass substrate 11.

A PDP manufactured by the method for manufacturing a PDP according to the first embodiment has a structure in which a front substrate 10 having a plurality pairs of display electrodes 12 for generating surface discharges and a rear substrate 20 having a plurality of address electrodes 22 are opposed so that the pair of display electrodes 12 and the address electrode 22 cross each other to constitute a three-electrode structure and thereby to provide a display region and in which discharge spaces 40 are defined by rib barriers 24 provided between the front substrate 10 and the rear substrate 20 and are filled with a mixture of xenon and neon as a discharge gas.

The front substrate 10 has the display electrodes 12, the dielectric layer 13, and the protective layer 14 formed in this order on the glass substrate 11. The pair of display electrodes 12 for generating surface discharges, arranged side by side on the glass substrate 11, each are made up of the transparent electrode 12a and the bus electrode 12b. The bus electrode 12b has a higher conductivity to compensate for the conductivity of the transparent electrodes 12a. The dielectric layer 13 is for sustaining electric discharges generated by a wall voltage, and is made of a low-melting glass having a thickness of several tens of [μm]. The protective film 14 is made of MgO, and has a thickness of several thousands of [Å] on the dielectric layer 13. In addition to having the ordinary structure described above, the front substrate 10 is constructed so that the recess 15 is formed at a discharge gap with a bottom portion 15a of the recess 15 being located at a level lower than a surface of the glass substrate 11 that has the display electrode 12 formed thereon, and more precisely, with the bottom portion 15a being located at a level lower than a contact surface 16 between the transparent conductive film 12c and the dielectric layer 13, which is a surface parallel with the plane of the glass substrate 11. In the above structure of the front substrate 10 in which the bottom portion 15a is located at the level lower than the contact surface 16, there is formed at the time of application of an electric discharge voltage an electric line of force extending substantially linearly at the discharge gap as shown in FIG. 2(a) which is an enlarged view of an essential part of FIG. 1(b). On the other hand, in FIG. 2(b) which is an enlarged view of an essential part of a front substrate of a conventional PDP without the recess 15, there is formed at the time of application of the electric discharge voltage an electric line of force extending at the discharge gap as a long curve that pierces through the dielectric layer 13 and the protective layer 14. As seen from FIG. 3 that shows the relationship between an excavation amount d at the discharge gap shown in FIG. 1(b) and a firing voltage Vf, the firing voltage Vf is drastically decreased when the bottom portion 15a is located at the level lower than the contact surface 16, and it is substantially saturated at a low voltage V0 when the bottom portion 15a is located at a level lower than a contact surface 17 between the transparent conductive film 12c and the glass substrate 11, which is a surface parallel with the plane of the glass substrate 11. Accordingly, the bottom portion 15a is desirably located at the level lower than at least the contact surface 16. Provided that the length of the discharge gap is 100 μm, more specifically, the recess 15 may have a lateral length of 40 μm and a depth of 30 to 40 μm measured in the same direction as the display electrode extends.

Forming the recess 15 substantially eliminates portions of the dielectric layer 13 and the protective layer 14 that in the prior art are present at the discharge gap, reducing the capacity between the pair of display electrodes 12 and the reactive power. Potentials required for electric discharges, namely a firing voltage and a sustain voltage, can be lowered to decrease an electrode width and thus increase a discharge slit, making a positive column available at a long discharge gap, allowing for electric discharges with a higher efficiency. Electric discharges occur more distant from the phosphor layers 25, suppressing phosphor degradation. Due to the lowering of the voltages required for electric discharges, the increase in the firing voltage can be suppressed even if the partial pressure of Xe is increased, realizing a PDP having a high luminance and a high efficiency. More specifically, in a surface-discharge type PDP using a gas mixture of Ne and Xe, increase in the partial pressure of Xe by 1 [%] usually allows for a rise in the firing voltage by 4 [V] and an improvement in the efficiency by about 1.1 [-fold]. By forming the recess 15, however, the firing voltage can be lowered by about 20 [V], and even with the partial pressure of Xe increased by 5 [%], the PDP can be operated with the same voltage margin and with the efficiency improved by 1.5 [-fold].

The rear substrate 20 has address electrodes 22 in a striped configuration, a dielectric layer 23 and barrier ribs 24 formed in this order on the glass substrate 21. The barrier ribs 24 are formed between the address electrodes 22. The address electrode 22 is made of Cr, Cu and Cr films stacked in this order. The barrier rib 24 is made of a low-melting glass having a thickness of 130 [μm] to 150 [μm]. Phosphor layers 25 are formed between the barrier ribs 24 to cover a surface of the dielectric layer 23 and sidewalls of the barrier rib 24. The phosphor layers 25 are in three colors (red, green and blue) and are sequentially arranged between the barrier ribs 24. At the driving of the PDP, ultraviolet light of a short wavelength is provided by electric discharges between the pair of display electrodes 12 so as to excite the phosphor layers 25, which then emit light to perform display.

Now, the method for manufacturing a PDP according to the first embodiment of the present invention will be explained. The method is roughly divided into three processes: a process of manufacturing the front substrate 10, a process of manufacturing the rear substrate 20, and an assembly process. The assembly process includes bonding, sealing, exhaust of air, and enclosure of the discharge gas. In the below, first, the process of manufacturing the front substrate 10 which is a feature of the present invention will be explained in detail, and next, the process of manufacturing the rear substrate 20 and the assembly process will be explained.

In the process of manufacturing the front substrate 10, first, a thin film of tin oxide (SnO₂), a thin oxide film of an alloy of indium and tin (ITO film) or the like film is formed as the transparent conductive film 12c to a thickness of 0.2 [μm] on the entire surface of the glass substrate 11 by sputtering (FIG. 4(b)). On the transparent conductive film 12c, a laminated layer 12d of Cr, Cu and Cr films is formed by sputtering to a thickness of 2 [μm] to 3 [μm] (FIG. 4(c)). The resulting surface of the front substrate 10 is covered with a resist 18 (FIG. 4(d)), and the resist 18 is etched by photolithography into a pattern (FIG. 4(e)) to form the bus electrode 12b (FIGS. 4(f) and 4(g)). Then, a resist 19 that is resistant to cutting with a metal abrasive is applied onto the surface of the front substrate 10 (FIG. 4(h). The resulting surface of the front substrate 10 is then exposed to light via a photomask and subjected to development so that the resist 19 is left on portions of the front substrate 10 other than ones to be cut by the sandblasting method (FIG. 4(i)). By ejecting, for example, an abrasive of hard aluminum from a sandblasting machine onto the glass substrate 11, on which the resist 19 is left in a pattern, the portions of the transparent conductive film 12c and the glass substrate 11 that are not covered with the resist 19 are cut (FIG. 4(j)). The transparent conductive film 12c, having a thickness of only 0.2 [μm], can be cut in a short time, and then the glass substrate 11 itself is cut. After the cutting, the resist 19 is removed with an alkaline solution to form an original recess 15b that will finally become the recess 15 (in reality, the original recess 15b is included in the recess 15 in meaning, although here, for the sake of convenience, the recess 15 is discriminated from the original recess 15b) and to form the transparent electrode 12a (FIG. 4(k)). The bottom portion 15a needs to be located at a level lower than the contact surface 16 as described above. For this reason, considering the thickness of the dielectric layer 13 and the thickness of the protective layer 14 to be formed later, it is necessary that the original recess 15b should be cut in the glass substrate 11 to a depth equal to or greater than a thickness given by subtracting the thickness of the transparent electrode 12a from the sum of the thickness of the dielectric layer 13 and the thickness of the protective layer 14. For example, when the transparent electrode 12a has a thickness of 0.2 [μm], the dielectric layer 13 has a thickness of 5 [μm] and the protective layer 14 has a thickness of 1 [μm], the original recess 15b must be cut to a depth of at least 5.8 [μm]. The sandblasting method can also be used for the formation of the barrier ribs 24 on the rear substrate 20 using the ability to cut about 200 [μm] of low-melting glass paste. Unlike a liquid etching which could possibly cause over-etching to make the electrode width uneven, the sandblasting method does not cause such an inconvenience. When the sandblasting method is used, it is only the cutting rate in the depth direction that should be considered. The recess 15 and the transparent electrode 12a can be formed by cutting and patterning in one operation, simplifying a manufacturing process of the front substrate 10. A low-melting glass paste is screen-printed on the entire surface of the glass substrate having the transparent electrode 12a and the recess 15 formed thereon, and the resulting substrate is fired to form the dielectric layer 13 (FIG. 4(l)). In a final step of the process of manufacturing the front substrate 10, a film of magnesium oxide (MgO) is formed on the dielectric layer 13 by a vapor deposition such as a vacuum deposition to provide the protective layer 14 (FIG. 4(m)).

In the process of manufacturing the rear substrate 20, first, a thin film of silver (Ag) or aluminum (Al) is formed on the entire surface of the glass substrate 21 by sputtering, and then patterned by photolithography to form the address electrodes 22. A low-melting glass paste is printed on the entire surface of the glass substrate 21 that has the address electrodes 22 formed thereon, and the resulting substrate is fired to form the dielectric layer 23 thereon to a predetermined thickness. Next, a low-melting glass paste is applied by the screen-printing method or the like onto the entire surface of the glass substrate 21 that has the address electrode 22 formed thereon. A dry film photoresist that is resistant to cutting with a metal abrasive is applied onto the low-melting glass paste, and the resulting glass substrate 21 is exposed to light and subjected to development so that a resist pattern is left to cover portions of the low-melting glass paste to be the barrier ribs 24. By ejecting a metal abrasive from the sandblasting machine onto the glass substrate 21, on which the resist pattern is left, the portions of the low-melting glass paste not to be the barrier ribs 24 are cut. After the cutting, the resist pattern is removed so that the portions of the low-melting point glass paste to be the barrier ribs 24 are left in the predetermined pattern. The resulting rear substrate 20 is introduced into a firing furnace and fired at 500 to 600° C. (In some cases, drying is carried out before the firing). The firing causes the portions of the low-melting glass paste in the predetermined pattern to sinter and causes a binder and a solvent contained therein to volatilize, and thus the portions of the low-melting glass paste become the barrier ribs 24. A phosphor paste is charged between the barrier ribs 24 in striped configuration, dried and fired to form the phosphor layer 25.

In the assembly process, a low-melting glass paste as a sealing material is applied with a dispenser onto the periphery within which the barrier ribs 24 are formed. After the application, the low-melting glass paste is dried and fired if necessary (the firing is for keeping the shape of the paste and not for complete sintering of it). The rear substrate 20 having the low-melting glass paste and the front substrate 10 are opposed, positioned and temporarily fastened with a clip. The substrates are sealed by utilizing a vent hole formed in at least one of the substrates for exhausting air from the discharge space 40 and for filling the discharge gas thereinto. Namely, air is exhausted through the vent hole to reduce the pressure of the discharge space 40. Due to the pressure reduced, an attraction force is created to cause the substrates to come closer to each other. The substrates are bonded to each other with the pressure being reduced in the discharge space 40, and are fired at about 400° C. in the firing furnace. The firing causes the low-melting glass paste to sinter, and thus the low-melting glass paste becomes a sealing member 31 that seals the substrates. Finally, air is exhausted from the discharge space 40 enclosed by the glass substrates 11 and 21 and the sealing member 31 to bring the discharge space 40 into a vacuum state, followed by introducing into the discharge space 40 the discharge gas as a mixture of neon (Ne) and xenon (Xe). Thus, the PDP is completed.

The method for manufacturing a PDP according to the first embodiment of the present invention comprises the steps of: forming a transparent conductive film 12c in at least a display region on a glass substrate 11; forming parallel bus electrodes 12b on the transparent conductive film 12c; patterning the transparent conductive film 12c and the glass substrate 11 by a sandblasting method into a predetermined configuration to form transparent electrodes 12a and recesses 15; forming a dielectric layer 13 to cover the transparent electrodes 12a and the bus electrodes 12b; and forming a protective layer 14 to cover the dielectric layer 13. Thus, as compared with conventional methods in which the transparent conductive film 12c is patterned to form the transparent electrode 12 and then recesses 15 are formed in the glass substrate in a step separate, the method according to the first embodiment is advantageous in that after the formation of the bus electrodes 12b, the transparent electrodes 12a and the recesses 15 can be formed simultaneously by the sandblasting method, simplifying the manufacturing process. In the method according to the first embodiment, if necessary, the glass substrate 11 is cut by the sandblasting method to form the recesses 15 to the depth equal to or greater than the thickness given by subtracting the thickness of the transparent electrode 12a from the sum of the thickness of the dielectric layer 13 and the thickness of the protective layer 14. Thus, in the method according to the first embodiment, since the recesses 15 are formed so that they have the depth equal to or greater than the thickness given by subtracting the thickness of the transparent electrode 12a from the sum of the thickness of the dielectric layer 13 and the thickness of the protective layer 14, electric discharges follow not an electric line of force that makes a detour but one that is provided between the opposed surfaces of the adjacent transparent electrodes to remarkably reduce the firing voltage.

In the method according to the first embodiment, the glass substrate is cut to the depth equal to or greater than the thickness given by subtracting the thickness of the transparent electrode 12a from the sum of the thickness of the dielectric layer 13 and the thickness of the protective layer 14. The depth to be cut, however, is determined by adjusting an abrasive and the force to be exerted on the abrasive, and when the depth to be cut is too small, the manufacturing costs will be raised because of the difficulty in adjustment. Even if the recesses 15 are formed excessively deep, no inconvenience will be caused in terms of a reduction in firing voltage as shown in FIG. 3. For this reason, the recesses 15 may be formed excessively deep.

### Second Embodiment

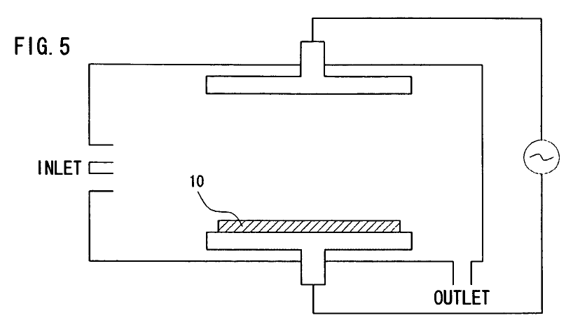

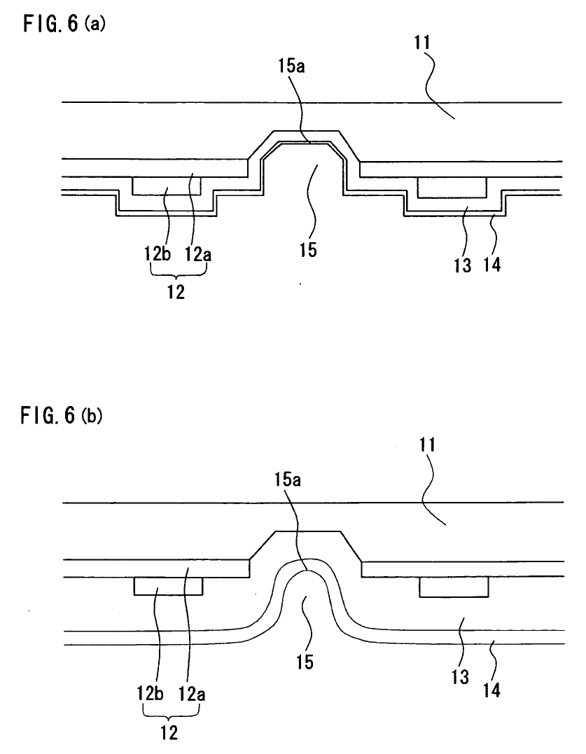

A method for manufacturing a PDP according to a second embodiment will be explained with reference to FIG. 5 and FIGS. 6(a) and 6(b). FIG. 5 is a schematic view illustrating the plasma CVD equipment according to the second embodiment; FIG. 6(a) is a perspective view illustrating an essential part according to the second embodiment; and FIG. 6(b) is a perspective view illustrating an essential part according to the first embodiment.

The method for manufacturing a PDP according to the second embodiment is the same as that according to the first embodiment except that the dielectric layer 13 of the front substrate is formed by the plasma CVD method.

The plasma CVD method is a method comprising selecting an appropriate gas, generating electric discharges in the atmosphere of the gas to create an extremely active plasma state, and placing a substrate in the plasma state to form a uniform thin film to a desired thickness on the substrate. The method is also referred to as a chemical vapor deposition method. FIG. 5 is a schematic view of a plasma CVD equipment to be used for the plasma CVD method. In the plasma CVD equipment, which is a parallel-plate type equipment, two or more different gases are introduced from respective inlets into a vacuum chamber to form the dielectric layer 13. In the case where the dielectric layer 13 is formed of SiO₂, the gases to be introduced in combination are: SiH₄ and N₂O; TEOS and O₂, SiO₄ and CO₂; or SiH₄ and CO₂. In the case where the dielectric layer 13 is formed of CH₃SiO, they are Si(CH₃)₄ and H₂O. In order to reduce its variation with time, the dielectric layer 13 may have a two-tier structure with a lower tier of SiO₂ formed of SiH₄ and N₂O and an upper tier of SiN formed of SiH₄ and N₂, or a two-tier structure with a lower tier of SiO₂ formed of a combination of SiH₄ and N₂O and an upper tier of SiON formed of a combination of SiH₄, N₂ and N₂O, or a three-tier structure with a lower tier of SiO₂ formed of a combination of SiH₄ and N₂O, a middle tier of SiON formed of a combination of SiH₄, N₂ and N₂O, and an upper tier of SiN formed of a combination of SiH₄ and N₂. The conditions for forming the thin film are a high-frequency output of 1.5 [kW] to 3.0 [kW], a substrate temperature of 350 [° C.] to 450 [° C.], and a degree of vacuum of 0.7 [Torr] to 2.5 [Torr], depending on the gases introduced. The above examples of gases introduced are given only for illustration purpose and any gases may be used insofar as they are necessary for forming the dielectric layer by the plasma CVD method.

Now, a method for manufacturing a PDP according to the second embodiment of the present invention will be explained by incorporating the method for manufacturing a PDP according to the first embodiment. The front substrate 10 having the original recess 15b and the transparent electrode 12a formed in and on the glass substrate 11 (FIG. 4(k)) is placed in the vacuum chamber of the plasma CVD equipment. The pressure of the vacuum chamber is reduced to a predetermined value. While introducing gases into the vacuum chamber, a voltage is applied between the electrodes of the plasma CVD equipment. By maintaining this state, a substance produced by a chemical reaction can be deposed on a surface of the glass substrate 11 to form the dielectric layer 13 thereon. Finally, the film of magnesium oxide (MgO) is formed to provide the protective layer 14. Thus, the front substrate 10 is completed (FIG. 6(a)). FIG. 6(b) shows the front substrate 10 produced by the method for manufacturing a PDP according to the first embodiment. Comparing the front substrate 10 according to the first embodiment, in which the dielectric layer 13 is formed by screen-printing and firing, and the front substrate 10 according to the second embodiment, in which the dielectric layer 13 is formed by the plasma CVD method, they are different in the thickness of the dielectric layer 13 and thus in the location of the bottom portion 15a although they are the same in the depth of the recess 15 cut in the glass substrate 11 by the sandblasting method. To provide the bottom portion 15a in the same location, it is necessary that the glass substrate 11 of the front substrate 10 according to the first embodiment should be cut deeper by the sandblasting method. From this, it is understood that the use of the plasma CVD method is more advantageous. For the process of manufacturing the rear substrate 20 and the assembly process, they are carried out in the same manner as in the method according to first embodiment.

In the method for manufacturing a PDP according to the second embodiment, in which the dielectric layer 13 of the front substrate 10 is formed by the plasma CVD method, the dielectric layer 13 has so small a dielectric constant and thickness that it can be easily controlled. Further, unlike the method according to the first embodiment in which the dielectric layer 13 is formed of a low-melting glass by the screen-printing method, the method according to the second embodiment includes no firing step, thereby simplifying the process and reducing the effect of substrate shrinkage. Also, especially when the recess 15 needs to be formed at the discharge gap as in the present invention, the method according to the second embodiment is advantageous in that, by utilizing a chemical reaction, the dielectric layer 13 can be formed as a uniform film having a small thickness to follow the contour of the front substrate 10 with preciseness of micro, although in general it is difficult to form the dielectric layer 13 beneath the recess 15. Also, in the method according to the second embodiment, since the dielectric layer 13 is formed as a thin film by the plasma CVD method, the thickness of the portion of the dielectric layer 13 that is in contact with the display electrode 12 can be reduced to lower the firing voltage and thereby to increase the partial pressure of Xe, realizing a PDP having a high efficiency and a high luminance. Further, in the method according to the second embodiment, the dielectric layer 13 can be controlled with high accuracy, contributing the miniaturization of a cell structure in a panel.

In the method for manufacturing a PDP according to the second embodiment, in place of the plasma CVD method, a vapor deposition method such as a sputtering vapor deposition may be employed for forming the thin layer. However, considering the importance of coverage around the transparent electrode 12a (especially, coverage of the side walls thereof that form a step), the CVD method is an optimum method since it achieves the highest coverage of all vapor deposition methods.

### Third Embodiment

Now, a method for manufacturing a PDP according to the third embodiment of the present invention will be explained.

The method for manufacturing a PDP according to the third embodiment is the same as the method according to the first embodiment except that the dielectric layer 13 of the front substrate 10 is made of a dielectric sheet.

The dielectric sheet is made of a supporting film and a film formation material layer formed on the supporting film. The supporting film is preferably made of a resin having a resistance to heat, a resistance to a solvent and a resiliency (a property of being resilient), and more specifically, made of polyethylene terephthalate, polyester or the like. The film formation material layer is formed by applying a glass paste (made of glass powder, a binding resin and a solvent) onto the supporting film to a uniform thickness, and then by drying the glass paste to evaporate part of the solvent. The binding resin may be any insofar as it has an appropriate viscosity to bind the glass powder to the supporting film and insofar as it can be removed completely when it is subjected to a firing treatment. More specifically, the binding resin may be made of an acrylic-ester-base resin, a cellulose-based resin or the like. The glass powder and the solvent may be ones as contained in conventional glass pastes. Also, various additives such as a dispersant, a stabilizer and the like may be contained in the glass paste so as to serve as components of the film formation material layer. Then, on the film formation material layer provided on the supporting film, a protective film layer is formed to prevent the solvent contained in the film formation material layer from evaporating. Thus, the dielectric sheet is completed.

Now, the method for manufacturing a PDP according to the third embodiment of the present invention will be explained by incorporating the method for manufacturing a PDP according to the first embodiment. The protective film layer of the dielectric sheet is exfoliated, and the resulting dielectric sheet is then placed on the front substrate 10 with a surface of the resulting dielectric sheet that has the film formation material layer being in contact with a surface of the front substrate 10 that has the original recess 15b and the transparent electrode 12a (FIG. 4(k)). The dielectric sheet and the front substrate 10 are thermocompression-bonded together by a heat roller, and then only the supporting film is exfoliated. After the exfoliation, the front substrate 10 is in a state of having the film formation material layer transferred on its surface. Next, the front substrate 10 is introduced into the firing furnace and fired so that the binding resin, the solvent and various additives contained in the film formation material layer are decomposed and eliminated, sintering the glass powder, forming the dielectric layer 13. Finally, the film of magnesium oxide (MgO) is formed to provide the protective layer 14. Thus, the front substrate 10 is completed.

For the process of manufacturing the rear substrate 20 and the assembly process, they are carried out in the same manner as in the method according to first embodiment.

In the method according to the second embodiment, the dielectric layer 13 of the front substrate 10 is made of the dielectric sheet. The method according to the second embodiment includes a firing step like a method in which the dielectric layer is formed by the screen-printing method. The method according to the second embodiment is advantageous in that the dielectric layer 13 of the front substrate 10, which is formed of the dielectric sheet, can have a uniform thickness. Also, especially when the recess 15 needs to be formed at the discharge gap as in the present invention, the method of the third embodiment is advantageous in that, although in general it is difficult to form the dielectric layer 13 beneath the recess 15, the dielectric layer 13 can be formed as a uniform film having a small thickness to follow the contour of the front substrate 10, since in the method according to the third embodiment, the glass paste is dried to evaporate part of the solvent to the extent that the glass paste keeps a predetermined shape, unlike the glass paste used in the method according to the third embodiment in which the dielectric layer is made by the screen-printing method. Also, in the method according to the third embodiment, since the dielectric layer 13 is formed of the dielectric sheet having a small thickness, the thickness of the portion of the dielectric layer 13 that is in contact with the display electrode 12 can be reduced to lower the firing voltage and thereby to increase the partial pressure of Xe, realizing a PDP having a high efficiency and a high luminance. Further, in the method according to the third embodiment, the dielectric layer 13 can be controlled with high accuracy, contributing the miniaturization of a cell structure in a panel.

### Other Embodiments

The methods according to the embodiments given so forth for manufacturing a PDP in which the discharge spaces 40 are defined on a column basis by the barrier ribs 24 extending in only one direction can be applied to manufacture a PDP in which discharge spaces are defined on a unit-luminous-area basis by barrier ribs arranged in a matrix configuration. In such a PDP having the discharge spaces defined on a unit-luminous-area basis, forming an exhaust path for exhausting air is a problem. Applying the present invention, in which the recess 15 is formed at the discharge gap in the front substrate, eliminates the need to additionally form the exhaust path since the recess 15 serves as the exhaust path to ensure exhaustion of air and gases from the unit luminous area, making it possible to manufacture a highly reliable PDP. Also in the methods according to the embodiments given so forth for manufacturing a PDP in which the discharge spaces 40 are defined on a column basis by the barrier ribs 24 extending in only one direction, the recess 15 can serve as the exhaust path.

In the method according to the second embodiment, the recess 15 may be formed with a taper as shown in FIG. 2(a) by cutting the glass substrate 11 through the sandblasting method. In the method according to the second embodiment, the plasma CVD method is used to form dielectric layer 13 of the front substrate 10 by depositing a substance produced through a chemical reaction so that the dielectric layer 13 is provided as a thin film having a substantially uniform thickness to follow the contour of the surface of a target on which the film is formed. Forming the recess 15 with a taper facilitates deposition of the substance produced through a chemical reaction on the bottom portion of the recess to ensure the formation of the dielectric layer 13 having a uniform thickness. Also in the method according to the third embodiment, by cutting the glass substrate 11 through the sandblasting method, the recess 15 may be formed with a taper as shown in FIG. 2(a), namely without any perpendicular surfaces but with a wide angle formed between a bottom surface and side surfaces thereof as shown in FIG. 2(a). The recess 15 with a taper makes it easier to laminate the dielectric sheet and to form the dielectric layer 13 having a uniform thickness as compared with a recess with perpendicular surfaces. When the sandblasting method is used, the recess is formed with a tilted periphery. This is because although an abrasive is ejected in narrow stream from an opening of a blast gun, part of the abrasive that is ejected from the circumference of the opening disperses, due to the atmospheric resistance or another cause, before reaching the target to be cut. Thus, when the sandblasting method is used, the recess is formed with a somewhat taper. However, when it is an intention that the recess is formed with a greater taper to ensure that the dielectric layer 13 and the protective layer are formed to uniform thicknesses, the intention is accomplished either by providing a larger opening to the blast gun, by ejecting the abrasive from the blast gun held a distance away from the target to be cut, or by ejecting the abrasive from the blast gun held in a slant position. Especially when it is an intention that only the side surfaces of the recess are tapered with the surface of the bottom portion 15a made substantially flat, the intention is accomplished by, for example, ejecting the abrasive with the blast gun held in a slant position so as to cut mainly the sidewalls.

In the methods according to the embodiments given so forth, it is possible to manufacture a PDP in which the recess 15 is formed with the bottom portion 15a being located at a level lower than the surface of the glass substrate 11 having the display electrode 12 formed thereon and in which the dielectric layer 13 is formed to follow the contour made by the display electrode 12. With the above constitution, the PDP has improved effects in thickness uniformity of the dielectric layer, driving operation, and yield rates or percentages of products that are identified as non-defectives. Equivalent effects can be produced if the dielectric layer 13 is formed on at least the display electrode 12 on which a wall voltage is to be formed so that the dielectric layer 13 follows the contour made by the display electrode 12, namely, if the dielectric layer 13 is formed on at least an area that assumes actual responsibility of electric discharges in conformity with the contour made by the display electrode 12.

The PDP manufactured by the methods according to the embodiments given so forth has the transparent electrode 12a. However, the display electrode 12 may be made of only the bus electrode 12b but not the transparent electrode 12a. If such is a case, by adjusting the distance of the discharge gap and the shape of the bus electrode 12b, the firing voltage can be reduced and also the step of forming the transparent electrode 12a can be eliminated, thereby significantly saving the time required for manufacturing the PDP. Since the bus electrode 12b has a higher conductivity compared with the display electrode 12a and the PDP with the recess requires less firing voltage as compared with the one without the recess, there is no need to provide a larger display electrode or cause the adjacent bus electrode 12b to come closer to each other, for generating electric discharges.

1. A method for manufacturing a plasma display panel, comprising the steps of:
forming a transparent conductive film in at least a display region on a glass substrate;
partly forming bus electrodes in parallel on the transparent conductive film;
cutting the transparent conductive film and the glass substrate by a sandblasting method into a predetermined configuration to form parallel transparent electrodes of a predetermined shape and to form recesses in the glass substrate between the transparent electrodes;
forming a dielectric layer to cover the bus electrodes and the transparent electrodes; and
forming a protective layer to cover the dielectric layer.

2. The method of claim 1, wherein the cutting is carried out so that the recesses have a depth equal to or greater than a thickness given by subtracting a thickness of the transparent electrode from the sum of a thickness of the dielectric layer and a thickness of the protective layer.

3. The method of claim 1, wherein the formation of the dielectric layer is carried out by CVD method.

4. The method of claim 1, wherein the dielectric layer is formed of a dielectric sheet.

5. The method of claim 3, wherein the cutting is carried out so that the recesses have a taper.

6. The method of claim 1, wherein the depth of the recess measured from a bottom portion thereof after the formation of the protective layer is greater than a distance between a surface of the protective layer opposite the dielectric layer and a surface of the transparent electrode opposite the glass substrate.

7. The method of claim 1, wherein the recess is formed in the glass substrate so that an electric line of force produced at application of an electric discharge voltage between the transparent electrodes extends substantially linearly at a discharge gap.

8. A plasma display panel comprising:
a front substrate that has a plurality pairs of display electrodes for generating surface discharges and that has recesses formed at discharge gaps between the adjacent display electrodes; and
a rear substrate that has a plurality of address electrodes,
the front and rear substrates being opposed,
wherein a bottom portion of the recess is located at a level lower than a surface of the glass substrate that has the display electrodes formed thereon, and the front substrate has a dielectric layer that follows contours made by the display electrodes.

9. The method of claim 2, wherein the formation of the dielectric layer is carried out by CVD method.

10. The method of claim 2, wherein the dielectric layer is formed of a dielectric sheet.

11. The method of claim 9, wherein the cutting is carried out so that the recesses have a taper.

12. The method of claim 4, wherein the cutting is carried out so that the recesses have a taper.

13. The method of claim 10, wherein the cutting is carried out so that the recesses have a taper.
